(19) United States
(12) Patent Application Publication
(10) Pub. No.: US 2012/0013213 A1
(43) Pub. Date: Jan. 19, 2012

(54) Hydrodynamic bearing assembly and motor having the same

(75) Inventor: Jin San Kim, Suwon (KR)

(73) Assignee: SAMSUNG ELECTRO-MECHANICS CO., LTD., Suwon (KR)

(21) Appl. No.: 12/929,312

(22) Filed: Jan. 13, 2011

(30) Foreign Application Priority Data
Jul. 13, 2010 (KR) 10-2010-0067342

(51) Int. Cl. F16C 32/06; H02K 7/08

(52) U.S. Cl. 310/90; 384/107

(57) ABSTRACT

There is provided a hydrodynamic bearing assembly and a motor having the same. The hydrodynamic bearing assembly includes a sleeve having a shaft inserted thereinto; a hub base coupled to an upper portion of the shaft and rotating together with the shaft; a stopper plate fixedly coupled to an upper surface of the sleeve and preventing the shaft from lifting while the shaft rotates; and a thrust dynamic pressure generating groove formed on at least one of an upper surface of the stopper plate and a lower surface of the hub base corresponding thereto.

### CROSS-REFERENCE TO RELATED APPLICATIONS

This application claims the priority of Korean Patent Application No. 10-2010-0067342 filed on Jul. 13, 2010, in the Korean Intellectual Property Office, the disclosure of which is incorporated herein by reference.

### BACKGROUND OF THE INVENTION

1. Field of the Invention

The present invention relates to a hydrodynamic bearing assembly and a motor having the same, and more particularly, to a hydrodynamic bearing assembly that has improved impact resistance and rotary precision by including a stopper in a stationary part, in which the stopper prevents the lifting of a shaft during the rotation of the shaft, and can be driven at a low level of current and a motor having the same.

2. Description of the Related Art

A small-sized spindle motor, used in a recording disc driving device, includes a stationary part, a rotary part coupled to the stationary part and rotating on an imaginary axis of rotation, a stopper preventing the separation of the rotary part, and lubricant fluid interposed between the rotary part and the stationary part. The rotation of the rotary part is supported by fluid pressure generated by the lubricant fluid.

The stopper is fixedly coupled to the rotary part. The stopper may include a flange-type stopper coupled to a shaft, a ring-type stopper coupled to a rotor case, and the like.

However, it is difficult to fabricate the flange-type stopper so as to be integrated with the shaft. In the case in which the flange-type stopper is separately fabricated and then assembled with the shaft, high-level fabrication qualities, such as sealing control, coaxial control and the like, are required.

Also, the ring-type stopper is subjected to solid friction, since no lubricant fluid is interposed between the stopper and the stationary part, thereby leading to an increase in abrasion and friction loss therebetween. There is the risk that particles produced by the abrasion may be drawn into a bearing.

### SUMMARY OF THE INVENTION

An aspect of the present invention provides a hydrodynamic bearing assembly that has improved impact resistance and rotary precision by including a stopper in a stationary part and interposing lubricant fluid between the stopper and a rotary part and can be driven at a low level of current and a motor having the same.

According to an aspect of the present invention, there is provided a hydrodynamic bearing assembly including: a sleeve having a shaft inserted thereinto; a hub base coupled to an upper portion of the shaft and rotating together with the shaft; a stopper plate fixedly coupled to an upper surface of the sleeve and preventing the shaft from lifting while the shaft rotates; and a thrust dynamic pressure generating groove formed on at least one of an upper surface of the stopper plate and a lower surface of the hub base corresponding thereto.

A gap may be provided between an inner circumferential surface of the stopper plate and an outer circumferential surface of the shaft corresponding thereto such that the gap may be filled with lubricant fluid.

The stopper plate may have an inner diameter smaller than that of the sleeve.

The shaft may include a stepped portion caught by an inner diameter lower portion of the stopper plate.

A meniscus of lubricant fluid may be formed between an outer circumferential surface of the sleeve and an inner circumferential surface of the hub base corresponding thereto.

The sleeve may include a bypass path connecting axial directional upper and lower portions of the sleeve and distributing pressure of lubricant fluid, and a groove formed in the axial directional upper portion of the sleeve and connecting the bypass path with a gap between the sleeve and the shaft to thereby allow the lubricant fluid within the bypass path to flow therebetween.

The stopper plate and the sleeve may be integrally formed.

According to another aspect of the present invention, there is provided a hydrodynamic bearing assembly including: a rotary part coupled to an upper portion of a shaft and rotating together with the shaft; a bearing part supporting rotations of the shaft and having a stopper formed on an inner diameter end portion of an axial directional upper portion thereof and caught by a stepped portion, the stepped portion being formed on an outer circumferential surface of the shaft so as to prevent the shaft from lifting while the shaft rotates; and a thrust dynamic pressure generating groove formed on at least one of an upper surface of the bearing part and a lower surface of the rotary part corresponding thereto.

A meniscus of lubricant fluid may be formed between an outer circumferential surface of the bearing part and an inner circumferential surface of the rotary part corresponding thereto.

The bearing part may include a bypass path connecting axial directional upper and lower portions of the bearing part and distributing pressure of lubricant fluid.

According to another aspect of the present invention, there is provided a motor including: a rotor including a hub base having a central hole into which a shaft is inserted and a magnet support extending from the hub base along an outer diameter direction and being bent downwardly in an axial direction to thereby support a magnet; a bearing part including a sleeve supporting rotations of the shaft and a stopper plate fixedly coupled to an upper surface of the sleeve and preventing the shaft from lifting while the shaft rotates; a stator coupled to an outer circumferential surface of the sleeve and including a core around which a coil is wound, the coil generating rotary driving force by an electromagnetic interaction with the magnet; and a thrust dynamic pressure generating groove formed on at least one of an upper surface of the stopper plate and a lower surface of the hub base corresponding thereto.

A gap may be provided between an inner circumferential surface of the stopper plate and an outer circumferential surface of the shaft corresponding thereto such that the gap may be filled with lubricant fluid.

The stopper plate may have an inner diameter smaller than that of the sleeve.

The shaft may include a stepped portion caught by an inner diameter lower portion of the stopper plate.

A meniscus of lubricant fluid may be formed between the outer circumferential surface of the sleeve and an inner circumferential surface of the hub base.

The sleeve may include a bypass path connecting axial directional upper and lower portions of the sleeve and distributing pressure of lubricant fluid, and a groove formed in the axial directional upper portion of the sleeve and connecting the bypass path with a gap between the sleeve and the shaft to thereby allow the lubricant fluid within the bypass path to flow therebetween.

The stopper plate and the sleeve may be integrally formed.

The hub base may include a circular plate having a circular hole, and a cylindrical wall bent from the circular plate downwardly in the axial direction and having an inner circumferential surface inclined so that lubricant fluid between the inner circumferential surface and the outer circumferential surface of the sleeve undergoes taper sealing.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a hydrodynamic bearing assembly and a motor having the same according to an exemplary embodiment of the present invention;

FIG. 2 is an enlarged view of portion A of FIG. 1;

FIG. 3 is a schematic perspective view illustrating a hydrodynamic bearing assembly according to an exemplary embodiment of the present invention;

FIG. 4 is a cut-away perspective view schematically illustrating a hydrodynamic bearing assembly according to an exemplary embodiment of the present invention;

FIG. 5 is a pattern view illustrating herringbone grooves of a thrust dynamic pressure bearing which is formed in a stopper plate according to an exemplary embodiment of the present invention; and

FIG. 6 is a pattern view illustrating spiral grooves of a thrust dynamic pressure bearing which is formed in a stopper plate according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

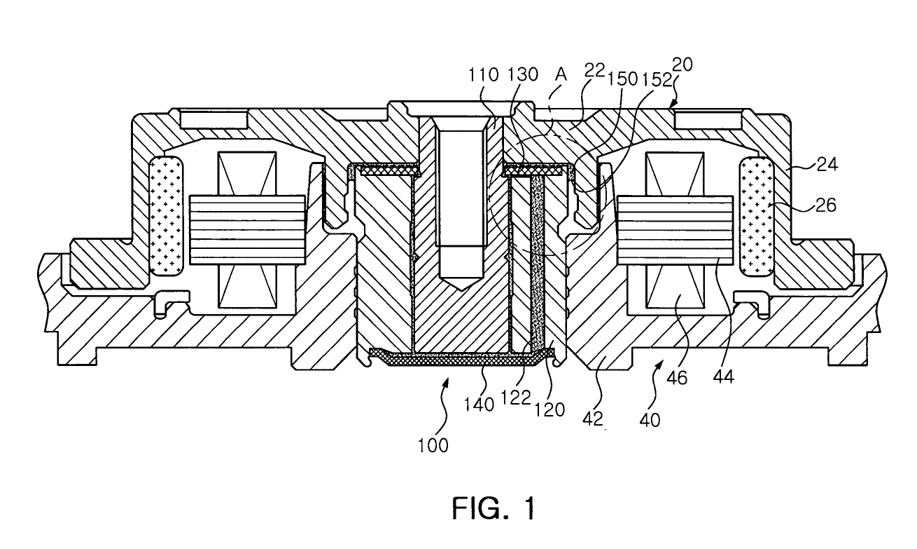

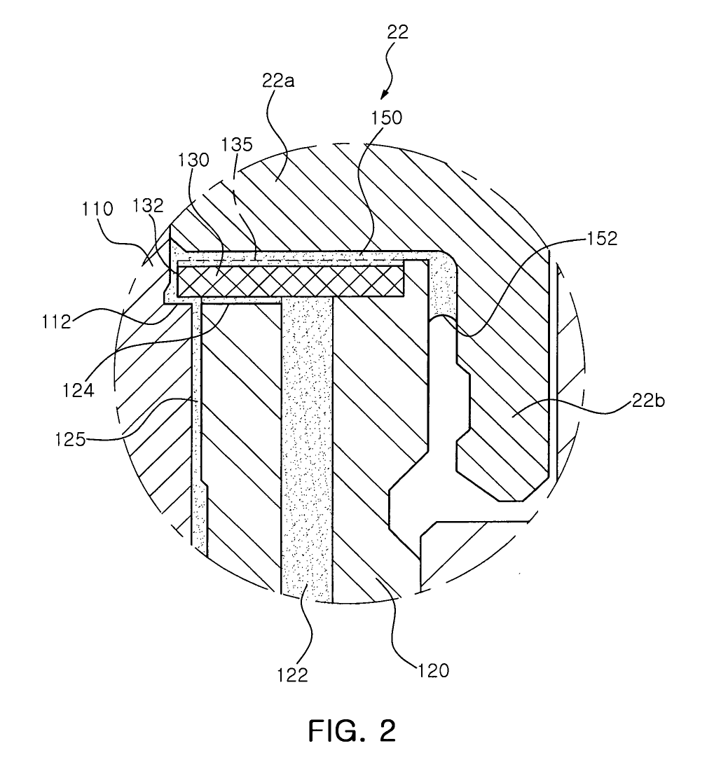

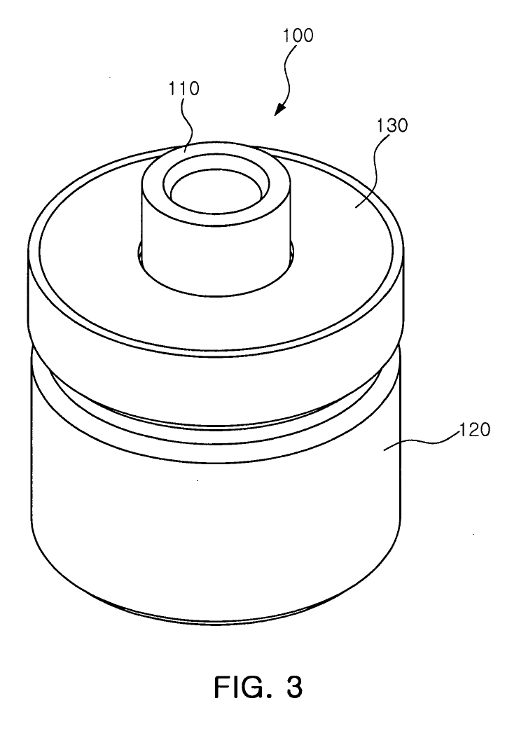

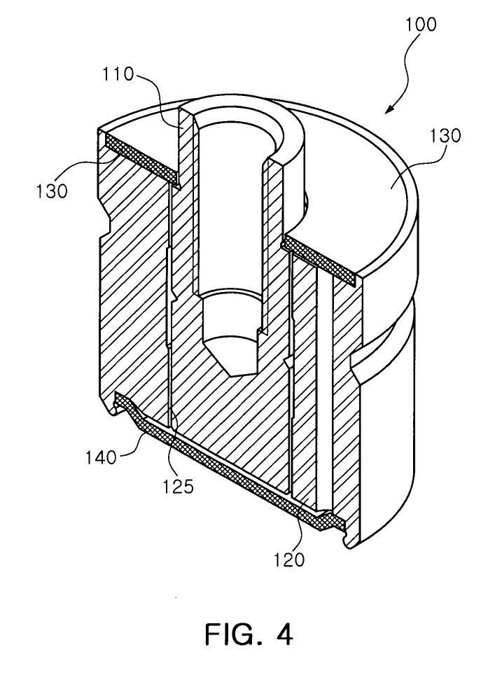

FIG. 1 is a schematic cross-sectional view illustrating a hydrodynamic bearing assembly and a motor having the same according to an exemplary embodiment of the present invention. FIG. 2 is an enlarged view of portion A of FIG. 1. FIGS. 3 and 4 are a perspective view and a cut-away perspective view, respectively, schematically illustrating a hydrodynamic bearing assembly according to an exemplary embodiment of the present invention.

With reference to FIGS. 1 and 2, a motor according to an exemplary embodiment of the invention may include a hydrodynamic bearing assembly 100, a rotor 20 and a stator 40.

Exemplary embodiments of the hydrodynamic bearing assembly 100 will be described below. The motor according to the present invention may have all the specific features of the respective exemplary embodiments of the hydrodynamic bearing assembly 100.

The rotor 20 is a rotary structure, which is provided to be rotatable with respect to the stator 40. The rotor 20 may include a rotor case having a ring-shaped magnet 26 corresponding to a core 44 with a predetermined interval therebetween along the inner circumferential surface thereof.

The magnet 26 is a permanent magnet that has north and south magnetic poles alternately arranged in a circumferential direction to generate a magnetic field having a predetermined magnitude. The rotor 20 rotates due to electromagnetic interaction between coils 46 and the magnet 26.

Here, the rotor case includes a hub base 22 and a magnet support 24. The hub base 22 is press-fitted to the upper end of a shaft 110 to be fixed thereto. The magnet support 24 extends from the hub base 22 along an outer diameter direction and is bent downwardly in an axial direction to thereby support the magnet 26 of the rotor 20.

The hub base 22 may include a circular plate 22a and a cylindrical wall 22b. The circular plate 22a has a central hole into which the shaft 110 is inserted. The cylindrical wall 22b is bent from the circular plate 22a downwardly in the axial direction and is formed to seal oil between the cylindrical wall 22b and the outer circumferential surface of a sleeve 120. Herein, the inner circumferential surface of the cylindrical wall 22b may be inclined so that the oil undergoes taper sealing.

Meanwhile, terms in regards to directions are defined as follows. As viewed in FIG. 1, the axial direction refers to a vertical direction on the basis of the shaft 110, and the outer or inner diameter direction refers to a direction of the outer end of the rotor 20 on the basis of the shaft 110 or a central direction of the shaft 110 on the basis of the outer end of the rotor 20.

The stator 40 is a stationary structure including the coils 46 generating electromagnetic force having a predetermined magnitude when power is applied thereto, and a plurality of cores 44 around which the coils 46 are wound.

The cores 44 are disposed to be fixed to the upper portion of a base 42 having a printed circuit board (not shown) on which a pattern circuit is printed. A plurality of coil holes having a certain size may be formed to penetrate part of the base 42 corresponding to the coils 46 such that the coils 46 are exposed through part of the base 42. The coils 46 are electrically connected to the printed circuit board so that external power is supplied thereto.

The hydrodynamic bearing assembly 100 may include the shaft 110, the sleeve 120, a stopper plate 130 and a cover plate 140.

With reference to FIGS. 3 and 4, the shaft 110 is inserted into a central hole formed in the center of the sleeve 120. The stopper plate 130 is disposed on the axial directional upper portion of the sleeve 120. The cover plate 140 is disposed under the shaft 110 and the sleeve 120.

Here, the shaft 110 is inserted into the central hole of the sleeve 120 with a fine gap 125 therebetween. Oil fills the fine gap 125, thereby supporting the rotation of the rotor 20 by dynamic pressure generated by a radial bearing formed in at least one of the outer diameter of the shaft 110 and the inner diameter of the sleeve 120. At this time, a groove having a herringbone shape or a spiral shape may be formed in the outer circumferential surface of the shaft 110. The groove and the fine gap are filled with oil, and the rotation of the shaft 110 is supported by the oil.

The cover plate 140 is formed of an elastic material such that the cover plate 140 is elastically deformed when coupled to the axial directional lower portion of the sleeve 120. In this manner, the cover plate 140 covers the lower portion of the sleeve 120, thereby supporting the sleeve 120 and the shaft 110. The cover plate 140 may be coupled to the sleeve 120 in a manner such that the outer circumferential surface of the cover plate 140 may contact the inner circumferential surface of the sleeve 120. However, the invention is not limited thereto. The cover plate 140 may be coupled to the sleeve 120 in a manner such that portions thereof bent towards the axial direction may contact the inner circumferential surface of the sleeve 120. A gap between the cover plate 140 and the sleeve 120 is filled with oil. This may serve as a bearing supporting the lower surface of the shaft 110.

The sleeve 120 has the central hole at the center thereof to allow the shaft 110 to be inserted thereinto. The outer circumferential surface of the sleeve 120 is coupled to the base 42 of the stator 40 at the lower portion thereof and faces the cylindrical wall 22b of the hub base 22 at the upper portion thereof. Here, a meniscus 152 of oil is formed between the upper portion of the outer circumferential surface of the sleeve 120 and the cylindrical wall 22b.

A groove having a spiral shape or a herringbone shape may be formed in the inner circumferential surface of the sleeve 120 in order to generate dynamic pressure between the inner circumferential surface of the sleeve 120 and the shaft 110.

Also, a bypass path 122 may be formed in a manner such that the axial directional upper and lower portions of the sleeve 120 are connected to each other. The bypass path 122 is provided in order to distribute the pressure of the oil. Here, a groove 124 may be formed in the axial directional upper portion of the sleeve 120 in a manner such that the groove 124 may be formed to connect the bypass path 122 with the fine gap 125 formed between the sleeve 120 and the shaft 110, thereby allowing the oil to flow therebetween.

The sleeve 120 may be formed by forging Cu or Al or sintering Cu—Fe alloy powder or SUS powder.

The axial directional upper portion of the sleeve 120 may be fixedly coupled to the stopper plate 130. The sleeve 120 and the stopper plate 130 may be adhered by an adhesive.

A fine gap may be formed between an inner circumferential surface of the stopper plate 130 and the outer circumferential surface of the shaft 110 and filled with lubricant fluid 150. Here, the lubricant fluid 150 may be oil.

The stopper plate 130 may include a protruding end portion 132 protruding inwardly of the inner circumferential surface of the sleeve 120 in a radial direction and caught by a stepped portion 112 formed on the outer circumferential surface of the shaft 110 when the shaft 110 rotates. That is, the inner diameter of the stopper plate 130 is smaller than that of the sleeve 120.

When the shaft 110 lifts due to oil pressure during the rotation thereof, the stepped portion 112 of the shaft 110 is caught by the protruding end portion 132 of the stopper plate 130, thereby preventing further lifting of the shaft 110.

A thrust dynamic pressure generating groove 135 may be formed on the upper surface of the stopper plate 130. The circular plate 22a of the hub base 22 and the upper surface of the stopper plate 130 may have oil filled therebetween as the lubricant fluid 150, and accordingly, a thrust bearing may be formed.

The thrust bearing may reduce friction between the hub base 22 and the stopper plate 130 while the shaft 110 and the rotor 20 perform a rotary motion, whereby the stable motion thereof can be maintained.

The thrust bearing is connected with the above-described radial bearing. That is, the gap between the stopper plate 130 and the hub base 22 is connected with the gap between the sleeve 120 and the shaft 110 and the oil injected into the respective gaps may freely flow and circulate.

In the present embodiment, the thrust dynamic pressure generating groove 135 may be formed on the upper surface of the stopper plate 130. However, the invention is not limited thereto. The thrust dynamic pressure generating groove 135 may be formed on the lower surface of the circular plate 22a or both the upper surface of the stopper plate 130 and the lower surface of the circular plate 22a.

In the present embodiment, the bypass path 122 is only formed in the sleeve 120 and the oil within the bypass path 122 is circulated through the groove 124 formed in the upper portion of the sleeve 120. However, the invention is not limited thereto. The bypass path 122 may be formed to penetrate the sleeve and the stopper plate in the axial direction. In this case, the oil within the bypass path may be circulated through the thrust dynamic pressure generating groove, so there is no need to form the groove 124.

In the present embodiment, the stopper plate 130 and the sleeve 120 are separately fabricated and then fixedly coupled to each other. However, the invention is not limited thereto. The stopper plate 130 and the sleeve 120 may be integrally formed. That is, the sleeve may be fabricated in a manner such that the axial directional upper end portion may be protruded inwardly of the inner circumferential surface in the radial direction in the central hole into which the shaft is inserted.

In the present embodiment, the lubricant fluid takes oil as an example. However, the invention is not limited thereto. The lubricant fluid may employ other fluid so long as it can reduce friction between a rotary part and a stationary part during a rotary motion to thereby support the rotary motion stably.

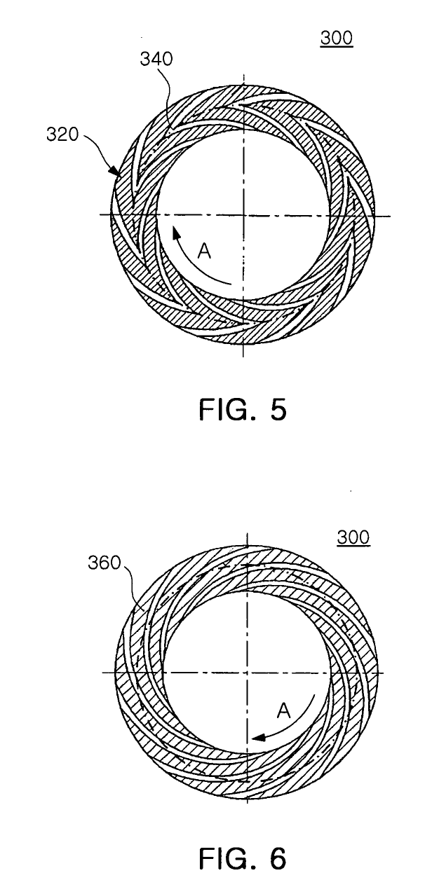

Hereinafter, a pumping groove 300, which is a thrust dynamic pressure generating groove, will be described with reference to FIGS. 5 and 6.

FIG. 5 is a pattern view illustrating herringbone grooves of a thrust dynamic pressure bearing which is formed in a stopper plate according to an exemplary embodiment of the present invention. FIG. 6 is a pattern view illustrating spiral grooves of a thrust dynamic pressure bearing which is formed in a stopper plate according to an exemplary embodiment of the present invention.

The pumping groove 300 of FIG. 5, which has a herringbone shape, is formed of continuous herringbone grooves 320 having intermediate curved portions 340. The pumping groove 300 of FIG. 6, which has a spiral shape, includes continuous spiral grooves 360.

In a hydrodynamic bearing structure in which a motor having the hydrodynamic bearing assembly according to the present invention rotates, when the rotary part including the shaft 110 and the rotor 20 rotates, the radial bearing is formed due to pressure generated by oil filling the fine gap 125 between the outer circumferential surface of the shaft 110 and the inner circumferential surface of the sleeve 120 and the thrust bearing is formed due to pressure generated by oil filling the fine gap between the upper surface of the stopper plate 130 and the lower surface of the hub base 22, especially the lower surface of the circular plate 22a.

At this time, the meniscus 152 is formed in a manner such that oil between the outer circumferential surface of the sleeve 120 and the cylindrical wall 22b of the hub base 22 is pumped due to the thrust dynamic pressure generating groove 135 formed on at least one of the upper surface of the stopper plate 130 and the lower surface of the circular plate 22a.

Since the stopper plate 130 is formed to be fixedly coupled to the axial directional upper portion of the sleeve 120 or to be integrated with the sleeve 120, the fine gap is formed between the inner circumferential surface of the stopper plate 130 and the outer circumferential surface of the shaft 110 and the fine gap may be filled with oil. Therefore, the thrust bearing may be connected with the radial bearing.

Meanwhile, since the bypass path 122, penetrating the sleeve 120 or both the sleeve 120 and the stopper plate 130 in the axial direction, may be filled with oil, the oil pressure of the radial bearing may allow the oil filling the gap between the axial directional lower surface of the sleeve 120 and the cover plate 140 to move into the bypass path 122.

At this time, the oil of the axial directional upper portion of the radial bearing may move into the bypass path 122 through the groove 124. In the case in which the bypass path is formed to penetrate the stopper plate 130 and the sleeve 120 in the axial direction, the oil may move into the bypass path through the thrust dynamic pressure generating groove 135.

In a hydrodynamic bearing assembly and a motor having the same according to the present invention, the rotary part includes only the shaft and the rotor, so it has a reduction in weight and thus improved impact resistance, and also is driven at a low level of current. Furthermore, since the number of rotary parts is reduced, unbalance that may be caused in the assembly process thereof can be reduced, whereby rotary precision can be improved.

As set forth above, in a hydrodynamic bearing assembly and a motor having the same according to exemplary embodiments of the invention, impact resistance and rotary precision are improved and oil sealing control is facilitated. Also, the hydrodynamic bearing assembly and the motor are driven at a low level of current.

While the present invention has been shown and described in connection with the exemplary embodiments, it will be apparent to those skilled in the art that modifications and variations can be made without departing from the spirit and scope of the invention as defined by the appended claims.

What is claimed is:

1. A hydrodynamic bearing assembly comprising:
a sleeve having a shaft inserted thereinto;
a hub base coupled to an upper portion of the shaft and rotating together with the shaft;
a stopper plate fixedly coupled to an upper surface of the sleeve and preventing the shaft from lifting while the shaft rotates; and
a thrust dynamic pressure generating groove formed on at least one of an upper surface of the stopper plate and a lower surface of the hub base corresponding thereto.

2. The hydrodynamic bearing assembly of claim 1, wherein a gap is provided between an inner circumferential surface of the stopper plate and an outer circumferential surface of the shaft corresponding thereto such that the gap is filled with lubricant fluid.

3. The hydrodynamic bearing assembly of claim 1, wherein the stopper plate has an inner diameter smaller than that of the sleeve.

4. The hydrodynamic bearing assembly of claim 1, wherein the shaft includes a stepped portion caught by an inner diameter lower portion of the stopper plate.

5. The hydrodynamic bearing assembly of claim 1, wherein a meniscus of lubricant fluid is formed between an outer circumferential surface of the sleeve and an inner circumferential surface of the hub base corresponding thereto.

6. The hydrodynamic bearing assembly of claim 1, wherein the sleeve comprises:
a bypass path connecting axial directional upper and lower portions of the sleeve and distributing pressure of lubricant fluid; and
a groove formed in the axial directional upper portion of the sleeve and connecting the bypass path with a gap between the sleeve and the shaft to thereby allow the lubricant fluid within the bypass path to flow therebetween.

7. The hydrodynamic bearing assembly of claim 1, wherein the stopper plate and the sleeve are integrally formed.

8. A hydrodynamic bearing assembly comprising:
a rotary part coupled to an upper portion of a shaft and rotating together with the shaft;
a bearing part supporting rotations of the shaft and having a stopper formed on an inner diameter end portion of an axial directional upper portion thereof and caught by a stepped portion, the stepped portion being formed on an outer circumferential surface of the shaft so as to prevent the shaft from lifting while the shaft rotates; and
a thrust dynamic pressure generating groove formed on at least one of an upper surface of the bearing part and a lower surface of the rotary part corresponding thereto.

9. The hydrodynamic bearing assembly of claim 8, wherein a meniscus of lubricant fluid is formed between an outer circumferential surface of the bearing part and an inner circumferential surface of the rotary part corresponding thereto.

10. The hydrodynamic bearing assembly of claim 8, wherein the bearing part comprises a bypass path connecting axial directional upper and lower portions of the bearing part and distributing pressure of lubricant fluid.

11. A motor comprising:
a rotor including a hub base having a central hole into which a shaft is inserted and a magnet support extending from the hub base along an outer diameter direction and being bent downwardly in an axial direction to thereby support a magnet;
a bearing part including a sleeve supporting rotations of the shaft and a stopper plate fixedly coupled to an upper surface of the sleeve and preventing the shaft from lifting while the shaft rotates;
a stator coupled to an outer circumferential surface of the sleeve and including a core around which a coil is wound, the coil generating rotary driving force by an electromagnetic interaction with the magnet; and
a thrust dynamic pressure generating groove formed on at least one of an upper surface of the stopper plate and a lower surface of the hub base corresponding thereto.

12. The motor of claim 11, wherein a gap is provided between an inner circumferential surface of the stopper plate and an outer circumferential surface of the shaft corresponding thereto such that the gap is filled with lubricant fluid.

13. The motor of claim 11, wherein the stopper plate has an inner diameter smaller than that of the sleeve.

14. The motor of claim 11, wherein the shaft includes a stepped portion caught by an inner diameter lower portion of the stopper plate.

15. The motor of claim 11, wherein a meniscus of lubricant fluid is formed between the outer circumferential surface of the sleeve and an inner circumferential surface of the hub base.

16. The motor of claim 11, wherein the sleeve comprises:
a bypass path connecting axial directional upper and lower portions of the sleeve and distributing pressure of lubricant fluid; and
a groove formed in the axial directional upper portion of the sleeve and connecting the bypass path with a gap between the sleeve and the shaft to thereby allow the lubricant fluid within the bypass path to flow therebetween.

17. The motor of claim 11, wherein the stopper plate and the sleeve are integrally formed.

18. The motor of claim 11, wherein the hub base comprises:
a circular plate having a circular hole; and
a cylindrical wall bent from the circular plate downwardly in the axial direction and having an inner circumferential surface inclined so that lubricant fluid between the inner circumferential surface and the outer circumferential surface of the sleeve undergoes taper sealing.
